(19) United States
(12) Patent Application Publication
(10) Pub. No.: US 2006/0103578 A1
(43) Pub. Date: May 18, 2006

(54) Antenna device

(76) Inventors: Max Landaeus, Singapore (SG); Bjorn Cederberg, Shanghai (CN); Regina Sia, Singapore (SG)

Correspondence Address: BACHMAN & LAPOINTE, P.C., 900 CHAPEL STREET, SUITE 1201, NEW HAVEN, CT, 06510, US

(21) Appl. No.: 10/520,542

(22) PCT Filed: Jul. 7, 2003
(86) PCT No.: PCT/SE03/01178

§ 371 Date: Sep. 26, 2005

(30) Foreign Application Priority Data
Jul. 15, 2002 (SE) 0202209-3

(51) Int. Cl. H01Q 1/24

(52) U.S. Cl. 343/702

(57) ABSTRACT

An antenna device for a portable radiocommunications apparatus, a so-called cell or mobile telephone, has a carrier produced from electrically insulating and non-magnetic material. The carrier is fixable on a circuit card in the mobile telephone and supports a radiator. The radiator has a contactor device for contact with a corresponding contactor device on the circuit card. The carrier has an accommodation space in which an anchorage portion on the circuit card is insertible and fixable. The radiator is disposed on the distal end of the carrier seen from the circuit card.

### BACKGROUND OF THE INVENTION

(1) Field of the Invention

The present invention relates to an antenna device for a radiocommunications apparatus, for example a so-called cell or mobile telephone, comprising a carrier produced from electrically insulating and non-magnetic material, the carrier being fixable on a circuit card in the mobile telephone and supporting a radiator with a contactor device for contact with a corresponding contactor device on the circuit card.

(2) Prior Art

A large number of different antenna devices are previously known in the art for portable radiocommunications apparatuses, in daily parlance cell or mobile telephones. Many of these prior art constructions function excellently but may be unnecessarily bulky both as regards manufacture and assembly.

In a striving to reduce assembly costs, designs and constructions have been produced which comprise a carrier produced from an insulating plastic material on which the antenna is disposed. The carrier has anchorage devices often in the form of snap catches, by means of which the carrier is fixed on a circuit card in the mobile telephone at the same time as the contactor device of the radiator contacts with a so-called pad on the circuit card.

In such prior art constructions with a carrier and a radiator mounted thereon, it is common that the carrier is placed substantially inside the outer contour of the circuit card and that at least parts of the circuit card are utilised as earth plane. One such construction is called PIFA and requires relatively large volume.

The present invention has for its object to design the antenna device intimated by way of introduction so that it is accommodated within extremely compact dimensions, that it can be manufactured extremely rationally and economically in large series and that it permits extremely simple assembly. In addition, the present invention naturally has for its object to design the antenna device so that it enjoys superior electric properties, among other things the capability of operating in at least two mutually discrete frequency bands.

The objects forming the basis of the present invention will be attained if the antenna device intimated by way of introduction is characterised in that the carrier has an accommodation space into which an anchorage portion on the circuit card is insertible and fixable, and that the radiator is disposed on the side of the carrier facing away from the circuit card.

As a result of these features, there will be afforded a simple and economical assembly of the antenna device, at the same time as the radiator of the antenna device is disposed a distance from any possible disruptive metal components on the circuit card.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 shows, in the form of an exploded view, a first embodiment of the subject matter of the present invention, seen from beneath;

FIG. 2 shows the subject matter of the present invention according to FIG. 1, but seen from above;

FIG. 3 shows, in a view corresponding to that of FIG. 2, a modified embodiment of the present invention;

FIG. 4 shows, in a view corresponding to that of FIG. 1, the embodiment of FIG. 3;

FIG. 5 shows a carrier included in the embodiment according to FIGS. 1 and 2; and

FIG. 6 shows a carrier included in the embodiments according to FIGS. 3 and 4.

### DETAILED DESCRIPTION OF PREFERRED EMBODIMENT(S)

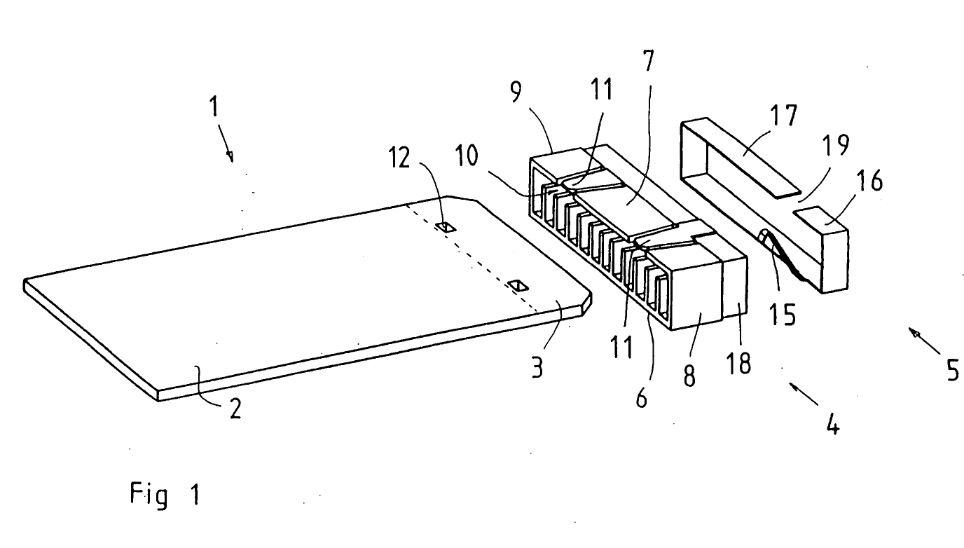

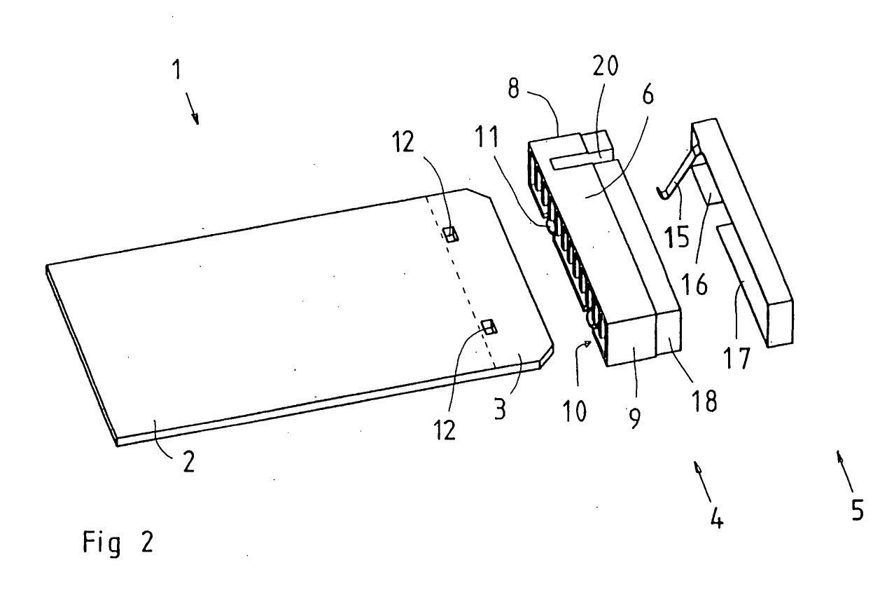

In FIGS. 1 and 2, reference numeral 1 relates to a circuit card included in a cell or mobile telephone, the circuit card having a first portion 2 with metallic conductors and a number of components mounted on the card. The circuit card 1 has a second portion 3 which is substantially completely free of metallic components, apart from a so-called pad which will be described in greater detail below. The second portion 3 of the circuit card 1 may also be designated an anchorage member and, consequently, serve for fixing a carrier 4 which supports a radiator 5.

The carrier 4 is manufactured from an electrically insulating and non-magnetic material, preferably a suitable plastic. The carrier has an outer, circumferential frame with two opposing longitudinal sides 6 and 7 and two opposing short sides 8 and 9. In the illustrated embodiment, the frame is in the form of a parallelepipedic casing or tube which interiorly in itself houses an accommodation space 10 in which the anchorage portion 3 of the circuit card is insertible. In one practical embodiment, the carrier may have the dimensions 30×8×8 mm.

The carrier 4 has anchorage members 11 which are designed for securing the frame on the circuit card. The anchorage members 11 of the frame or the carrier 4 are designed so as to cooperate with corresponding anchorage members on the anchorage portion 3. In the illustrated embodiment, these anchorage members are formed as apertures 12 or depressions in the anchorage portion.

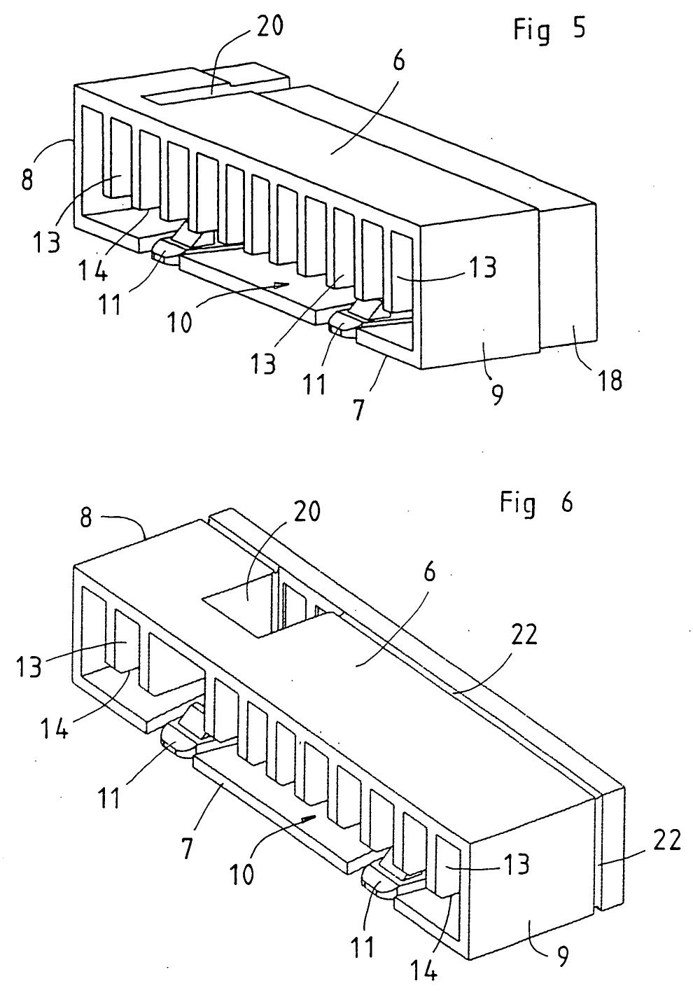

FIG. 5 shows, on a larger scale and in perspective, the carrier 4 in the embodiment according to FIGS. 1 and 2. It will be apparent from the Figure that there extend, from the inside of the first elongate side 6 of the frame, a number of lamellae 13 which, in FIG. 5, have lower, free edges 14. These lower, free edges define an upper defining surface of the accommodation space 10, while the inside of the lower longitudinal side 7 of the frame defines the lower defining surface of the accommodation space 10. The width of the accommodation space is defined by the insides of the two short sides 8 and 9.

The above-mentioned anchorage members 11 on the carrier 4 are designed as elongate, resilient fingers which are disposed on the one longitudinal side 7 of the carrier and which have their longitudinal directions transversely directed in relation to the longitudinal direction of the longitudinal side 6. In their free ends, the fingers have heels for snap-in anchorage in the apertures 12 of the anchorage portion 3.

It will be apparent from FIGS. 1 and 2 that the radiator 5, in the extended state, would approximately have the from of a T. In such instance, the foot of the T is designed as a contactor device 15 which has an inherent resilient capability and which is intended to contact that pad which is located on the anchorage portion 3 of the circuit card 1. This pad is then connected to the transmitter and receiver circuits in the mobile telephone via an adapter network.

Further, in the lateral, opposing direction, the T has projecting shanks 16 and 17 which are of different lengths. The laterally projecting shanks 16 and 17 are, in the assembled state of the antenna device, flexed so that they surround an edge portion 18 of the carrier 4. This edge portion 18 is located at that end of the carrier facing away from the circuit card 1 and extends along the end edge of this end. The edge portion 18 is countersunk inwardly so that the radiator 5 will not extend outside the outer surfaces of the both longitudinal sides 6 and 7 of the frame and its short sides 8 and 9.

It will further be apparent from the Figures that the radiator 5, between the ends of the two shanks 16 and 17, has an interspace 19 which is adapted in such a manner that a certain inductive or capacitative connection is obtained between the two shanks 16 and 17.

As a result of the presence of the two shanks 16 and 17 projecting in opposite directions and having different lengths, the radiator 5 is designed so as to be able to operate in two mutually discrete frequency bands. In such instance, the length of the longer shank 17 substantially determines the resonance frequency in the lower frequency band, while the resonance frequency in the higher frequency band is determined by a combination of the length of the shorter shank 16 and the size of the space 19, i.e. the connection between the two shanks. By such means, the connection is effective so that the resonance frequency is reduced with increased connection in both of the frequency bands, but to a considerably greater extent in the higher frequency band.

It was mentioned above that the radiator 5 is connected to the transmitter-receiver circuits in the mobile telephone via an adapter network. IN its simplest form, this adapter network can be designed as an inductance between the sole supply conductor to the contactor device 15 and earth. The adapter network is suitably placed on the first portion 2 of the circuit card 1.

It will be apparent from FIG. 2 that the carrier 4 has, on its one longitudinal side 6, an aperture 20 which extends to the interior of the carrier. The aperture is placed between two adjacent lamellae 13 and, as a result, permits the contactor device 15 on the radiator 5 to extend up to the anchorage portion 3 of the circuit card 1 and there make contact with the pad disposed there.

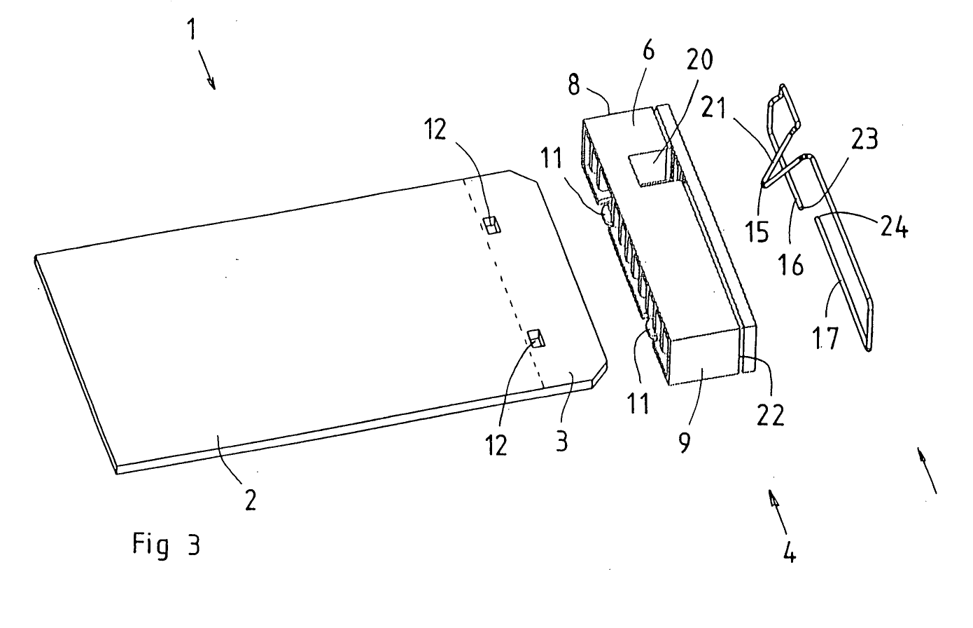

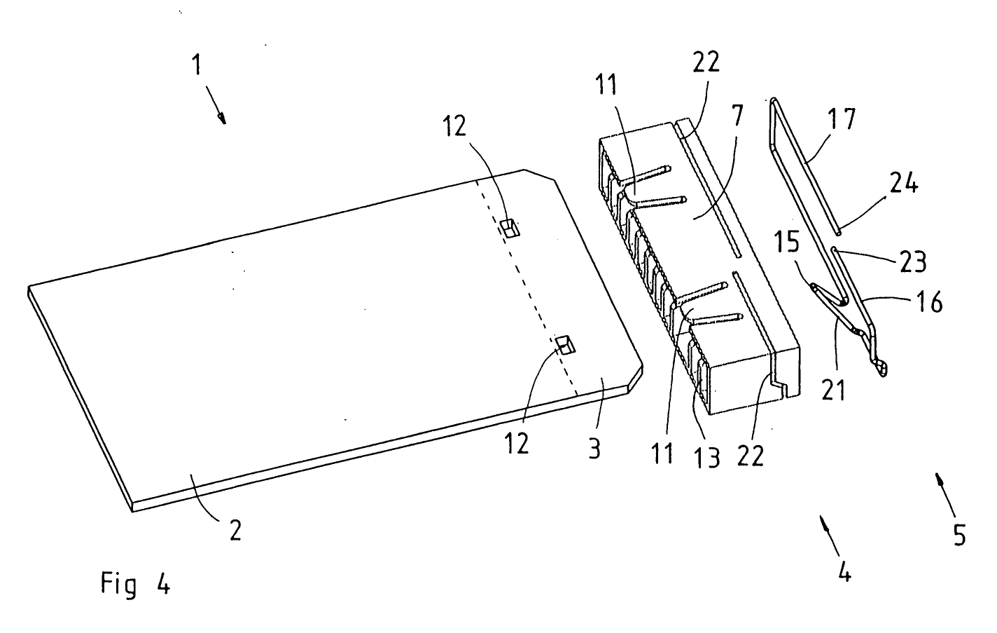

The embodiment according to FIGS. 3 and 4 differs only from the above-described embodiment in that the radiator 5 is produced from a resilient metal wire instead of a strip of sheet metal. The embodiment according to FIGS. 3 and 4 enjoys advantages compared with the above-described embodiment in that no special tools are required on forming the radiator. This implies that it is possible, in an extremely simple manner, to adapt the length of both shanks 16 and 17 of the radiator without modification in any tool. The embodiment according to FIGS. 1 and 2 requires, as was mentioned, some form of tool for producing the radiator 5, for example a punching tool, which does not permit such modifications at reasonable cost.

The radiator 5 in the embodiment according to FIGS. 3 and 4 further differs from the radiator according to FIGS. 1 and 2 in that its contactor device 15 consists of V-bent portion 21 of the metal wire employed. The radiator 5 has its contactor device 15 at the tip or apex of this V.

Also in the embodiment according to FIGS. 3 and 4, the material of the radiator is countersunk in a recess or in a circumferential groove 22 on the outside of the carrier 4. In analogy with that which applied to the embodiment according to FIGS. 1 and 2, this groove 22 is located in the proximity of the end of the carrier 4 facing away from the circuit card 1. It will be apparent from FIG. 4 that the ends 23 and 24 of the shanks 16 and 17 are offset so that they do not lie in line with one another. The offsetting of the ends 23 and 24 is, in this instance, effected in the insertion direction in the carrier 1 for the anchorage portion 3 of the circuit card, in which event the long shank 17 is to lie most distal from the circuit card, since the long shank operates with the largest wavelength and, counting in number of wavelengths, is therefore located more proximal the circuit card than the short shank 16. As a result of this offsetting, the electric connection between the ends of the shanks 16 and 17 can be adapted.

Embodiments are also possible where the shanks 16 and 17 are so long that they overlap. Also in such embodiment, the longest shanks should be located most distal from the circuit card 1.

It will further be clearly apparent from FIG. 6 that the carrier 4 also in this embodiment has an aperture 20 which fully corresponds to the above-described aperture in the carrier in the embodiment according to FIGS. 1 and 2. The difference resides however in the feature that the aperture 20 has been dimensioned with greater width in order to be able also to accommodate the widest section of the V-bent portion 21 of the radiator 5.

Also in this embodiment, use is made of the inherent resilient force in the radiator 5 in order to realise the requisite contact pressure between the contactor device 15 and the pad disposed on the anchorage portion of the circuit card 1.

In one alternative embodiment, it is possible to realise a greater electric length in both of the projecting shanks 16 and 17 in that these are designed in a meandering configuration. Alternatively, this greater electric length may be employed so as to reduce the outer overall dimension for both the radiator 5 and the carrier 4.

In yet a further alternative embodiment, it is possible to employ two radiators, on the one hand the radiator shown under reference numeral 5 and, on the other hand, additional radiators, for example for Bluetooth applications. Because of its higher frequency, the Bluetooth antenna should be placed between the radiator 5 and the circuit card and have its own supply means.

1-14. (canceled)

15. An antenna device for a portable radiocommunications apparatus, comprising a carrier produced from electrically insulating and non-magnetic material, the carrier being fixable on a circuit card in the portable radiocommunications apparatus and supporting a radiator with a contactor device for contact with a corresponding contactor device on the circuit card, the carrier having an accommodation space into which an anchorage portion of the circuit card is insertible and fixable; and the radiator being disposed on an end of the carrier facing away from the circuit card.

16. The antenna device as claimed in claim 15, wherein the anchorage portion extends outside a portion of the circuit card provided with an electrically conductive layer.

17. The antenna device as claimed in claim 15, wherein the carrier has a circumferential frame with a first wall which is formed for abutment against the anchorage portion, and a second, opposing wall which has a number of projections directed towards the first wall, with edge surfaces disposed to abut against the anchorage portion.

18. The antenna device as claimed in claim 17, wherein the first wall has resilient snap members for cooperation with corresponding members on the anchorage portion.

19. The antenna device as claimed in claim 18, wherein the snap members have locking heels, the corresponding members of the anchorage portion include apertures in the anchorage portion, and the locking heels are snap-fixable in the apertures.

20. The antenna device as claimed in claim 15, wherein the radiator is disposed on the outside of the carrier, extends around the carrier, and has a longitudinal direction transversely directed in relation to a direction of insertion of the anchorage portion in the carrier.

21. The antenna device as claimed in claim 20, wherein the radiator is disposed in a circumferential, external groove in the carrier.

22. The antenna device as claimed in claim 15, wherein the radiator in an extended, planar state approximately has the form of a T with a foot of the T constituting the contactor device.

23. The antenna device as claimed in claim 22, wherein laterally projecting shanks of the T are of different lengths.

24. The antenna device as claimed in claim 23, wherein there is provided, in the assembled state of the radiator on the carrier, a space between ends of the laterally projecting shanks of the T directed towards one another.

25. The antenna device as claimed in claim 23, wherein the ends of the shanks are offset in relation to one another in the direction of insertion of the circuit card in the carrier with a longest shank being located most distal from the circuit card.

26. The antenna device as claimed in claim 22, wherein the shanks are of such length that they overlap and a longest shank is located most distal from the circuit card.

27. The antenna device as claimed in claim 15, further comprising a second radiator.

28. The antenna device as claimed in claim 27, wherein the second radiator is disposed between the radiator disposed at the end of the carrier and the circuit card.
